(19) United States
(12) Patent Application Publication
(10) Pub. No.: US 2023/0115664 A1
(43) Pub. Date: Apr. 13, 2023

(54) RESOURCE MANAGEMENT FOR DISAGGREGATED ARCHITECTURES

(71) Applicant: Seagate Technology LLC, Fremont, CA (US)

(72) Inventor: Marc T. Jones, Longmont, CO (US)

(21) Appl. No.: 17/497,345

(22) Filed: Oct. 8, 2021

(51) Int. Cl. G06F 9/50; G06F 13/42

(52) U.S. Cl. CPC G06F 9/5005; G06F 13/4221; G06F 2213/0026

(57) ABSTRACT

A method includes managing, by a computer processing unit (CPU) in a first enclosure, a computing task. The method further includes determining, by a controller, that the computing task requires an additional resource. The controller selects an available resource from a pool of available resources in the first enclosure and in a second enclosure by comparing weighted paths between the first CPU and the available resources. Data is transferred between the CPU and the selected available resource to assist with the computing task.

### SUMMARY

In certain embodiments, a method includes managing, by a computer processing unit (CPU) in a first enclosure, a computing task. The method further includes determining, by a controller, that the computing task requires an additional resource. The controller selects an available resource from a pool of available resources in the first enclosure and in a second enclosure by comparing weighted paths between the first CPU and the available resources. Data is transferred between the CPU and the selected available resource to assist with the computing task.

In certain embodiments, a system includes a central controller with memory that stores instructions. When executed, the instructions cause the central controller to select a first available resource from a pool of resources—each communicatively coupled to a fabric—in a first enclosure and in a second enclosure by comparing a first set of weighted paths between a CPU and a first type of the resources. The instructions further cause the central controller to select a second available resource from the pool of resources by comparing a second set of weighted paths between the CPU and a second type of the available resources that is different than the first type. The instructions further cause the central controller to instruct the CPU to access the selected first available resource and the selected second available resource via the fabric and to transfer data between the CPU and the selected first and second available resources to assist with a computing task managed by the CPU.

In certain embodiments, a non-transitory computer-readable medium is disclosed, and the medium has instructions stored thereon that, when executed by a processor, cause the processor to carry out various functions. The functions include select a first available resource from a pool of resources—each communicatively coupled to a fabric—in a first enclosure and in a second enclosure by determining which path of a first set of weighted paths between a CPU and a first type of the resources is associated with a lowest weight. The functions further include select a second available resource from the pool of resources by determining which path of a second set of weighted paths between the CPU and a second type of the resources is associated with a lowest weight. The functions further include instruct the CPU to access the selected first available resource and the selected second available resource via the fabric and to transfer data between the CPU and the selected first and second available resources to assist with a computing task managed by the CPU.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a perspective view of a data storage system, in accordance with certain embodiments of the present disclosure.

FIG. 2 shows a block diagram of a data storage system with two subsystems, in accordance with certain embodiments of the present disclosure.

FIG. 3 shows a diagram of nodes of the data storage system of FIG. 2, in accordance with certain embodiments of the present disclosure.

FIG. 4 shows the data storage system of FIG. 2 with a first resource allocation, in accordance with certain embodiments of the present disclosure.

FIG. 5 shows the data storage system of FIG. 2 with a second resource allocation, in accordance with certain embodiments of the present disclosure.

FIG. 6 shows a simplified schematic of the second resource allocation of FIG. 5, in accordance with certain embodiments of the present disclosure.

FIG. 7 shows a block diagram of steps of a method, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

A disaggregated architecture is one type of architecture that can be used in connection with data storage systems. Disaggregated architectures allow physically separate data storage systems or subsystems to share resources between or among each other. These shared resources are sometimes collectively referred to as a pool of resources. One challenge with such architectures is managing the shared resources efficiently. Certain embodiments of the present disclosure are accordingly directed to managing how resources are allocated in disaggregated architectures.

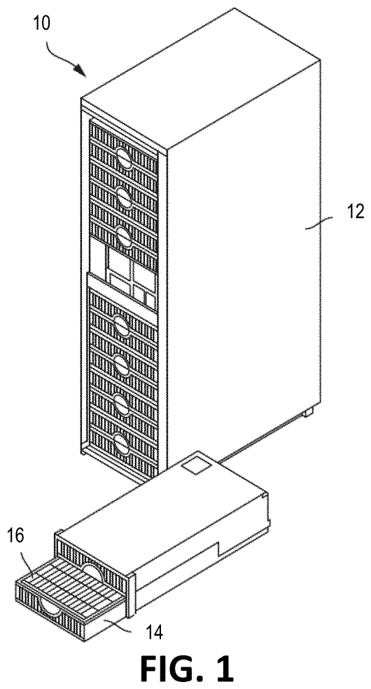

FIG. 1 shows a data storage system 10 including a rack 12 (e.g., a cabinet) with a plurality of enclosures 14 such as drawers. Each enclosure 14 can be configured as a sliding enclosure such that the drawer can extend horizontally away from the rack 12 to expose a set of data storage devices 16 installed within the enclosure 14. In some embodiments, the enclosures 14 are data storage blades.

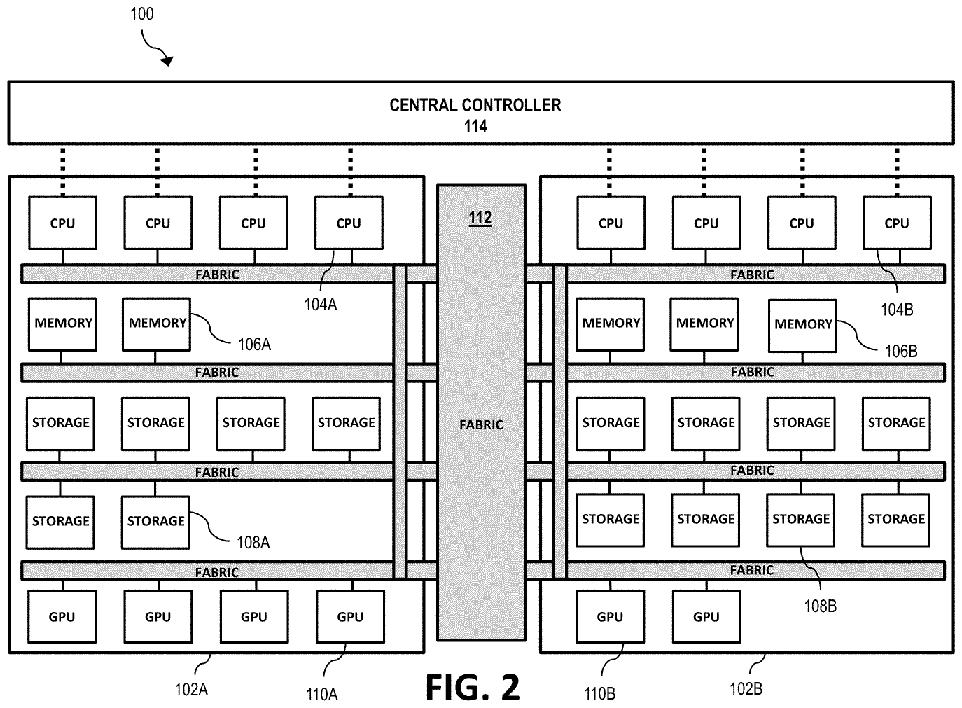

FIG. 2 shows a data storage system 100 that includes two separate enclosures 102A and 1026, which may be referred to as the first enclosure 102A and the second enclosure 1026. Although only two enclosures 102A and 1026 are shown in FIG. 2, the data storage system 100 can include more enclosures.

In certain embodiments, the enclosures 102A and 102B are separate racks similar to the rack 12 shown in FIG. 1. In other embodiments, the enclosures 102A and 1026 are separate enclosures that are positioned in the same rack such as the enclosures 14 shown in FIG. 1. In some embodiments, the enclosures 102A and 102B are separate data storage blades positioned in the same enclosure. In each of these approaches, the enclosures 102A and 102B are physically separate from each other.

Each enclosure 102A and 102B can house a set of computing resources, memory resources, and data storage resources. In the example of FIG. 2, each enclosure 102A and 102B physically houses respective sets of central processing units (CPUs) 104A and 104B, memory 106A and 106B, data storage devices 108A and 108B, and graphical processing units (GPUs)110A and 1106. For simplicity, not all CPUs, memory, etc., in FIG. 2 are labeled with their own reference number.

In certain embodiments, the CPUs 104A and 104B comprise integrated circuits such as microprocessors, field-programmable gate arrays (FPGAs), application-specific integrated circuits (ASICs), or combinations thereof that execute computer-readable instructions/code to perform various functions. Each CPU may be communicatively coupled to dedicated memory to assist with executing the instructions. The CPUs 104A and 1046 can manage computing tasks, which may require use of other computing resources, memory resources, and data storage resources in the enclosures 102A and 102B. These tasks can include running applications such as machine learning applications where at least one of the CPUs is managing/orchestrating how data is moved and processed (e.g., retrieving or storing data such as images from one or more data storage devices and using one or more GPUs to process the data via a convolutional neural network).

In certain embodiments, the memory 106A and 106B comprise computer-readable storage media in the form of volatile and/or nonvolatile memory and may be removable, non-removable, or a combination thereof. Media examples include Random Access Memory (RAM), Read Only Memory (ROM), Electronically Erasable Programmable Read Only Memory (EEPROM), flash memory, storage-class memory, and/or any other non-transitory storage medium that can be used to store information and can be accessed by a computing device. In certain embodiments, the data storage devices 108A and 108B comprises hard disk drives, optical disk drives, magnetic tape drives, and/or solid state drives. In certain embodiments, the GPUs 110A and 1106 comprise integrated circuits such as microprocessors that execute computer-readable instructions/code to perform various functions. Each GPU may be communicatively coupled to dedicated memory to assist with executing the instructions.

The data storage system 100 uses a disaggregated architecture such that the enclosures' respective sets of computing resources, memory resources, and data storage resources can be shared between the enclosures 102A and 1026. Disaggregated architectures are sometimes referred to as composable architectures.

Each of the CPUs 104A and 104B, memory 106A and 106B, data storage devices 108A and 108B, and GPUs 110A and 1106 are communicatively coupled to a fabric 112 (shaded regions in FIG. 2). These resources—interconnected via the fabric 112—can be considered to be a pool of resources available within the disaggregated architecture of the system 100.

The fabric 112 is used to interconnect these computing resources and data storage resources with each other. In certain embodiments, the fabric 112 is a data bus that is shared among the computing resources, memory resources, and data storage resources. For example, the data bus can be configured and designed for use with a particular interface standard such as a peripheral component interconnect express (PCIe) interface standard. In certain embodiments, the fabric 112 comprises multiple data busses. For example, each enclosure can include its own physical data bus, which is communicatively coupled to the data bus of the other enclosure(s) with switches therebetween.

The particular computing resources, memory resources, and data storage resources used in the data storage system 100 can be selected based on their ability to communicate with the chosen interface of the fabric 112. Using the PCIe interface standard, the resources (including the data storage devices 108A and 108B) can communicate data over the fabric 112 according to the non-volatile memory express (NVMe) specification.

Disaggregated architectures pool or aggregate computing resources, memory resources, and data storage resources together such that the resources can be elastically used (e.g., scaled up or down) for various applications and workloads. For example, the memory 1066, data storage devices 1086, and/or GPUs 1106 in the second enclosure 102B are available to be used (e.g., controlled, accessed) by one of the CPUs 104A in the first enclosure 102A to carry out a computing and/or data storage task.

Challenges with disaggregated architectures include managing the pooled resources efficiently and managing congestion along the fabric 112 or other sources of latency within the system 100. Congestion along the fabric 112 can reduce overall performance of the data storage system 100 because access to data may be delayed. Congestion can be caused by competing demands for use of the fabric 112 to communicate data between and among the various resources connected to the fabric 112. The amount of congestion will vary over time as demand rises and falls, and the amount of congestion may be different at different locations along the fabric 112.

In addition to performance penalties due to congestion, accessing resources from a different enclosure can cause delays in carrying out operations. In general, accessing intra-enclosure resources is faster than accessing inter-enclosure resources. For example, the path along the fabric 112 between one CPU 104A in the first enclosure 102A and memory 106B in the second enclosure 102B is longer than if the CPU 104A accessed memory 106A in the first enclosure 102A. As such, there are potential performance penalties associated with accessing resources positioned in another enclosure. However, there are circumstances where delay due to intra-enclosure congestion or demand can be greater than delay associated with intra-enclosure resource sharing.

To help address these potential performance penalties, the data storage system 100 can apply various rules or logic to manage how resources are allocated in a disaggregated architecture. These rules of logic can be carried out by a central controller 114. The central controller 114 can comprise an integrated circuit with a microprocessor, FPGAs, ASICs, or combinations thereof that includes or is coupled to memory that stores computer-readable instructions/code.

In certain embodiments, the central controller 114 is communicatively coupled to the CPUs 104A and 104B of the enclosures 102A and 102B. In some embodiments, the central controller 114 is communicatively coupled to respective host controllers of each enclosure 102A and 102B which are coupled between the central controller 114 and the CPUs 104A and 104B.

The central controller 114 can manage utilization of the computing resources, memory resources, and data storage resources of the data storage system 100 using graph theory approaches. Applying graph theory, the central controller 114 can compare available resources and determine which resources are more likely to provide better performance.

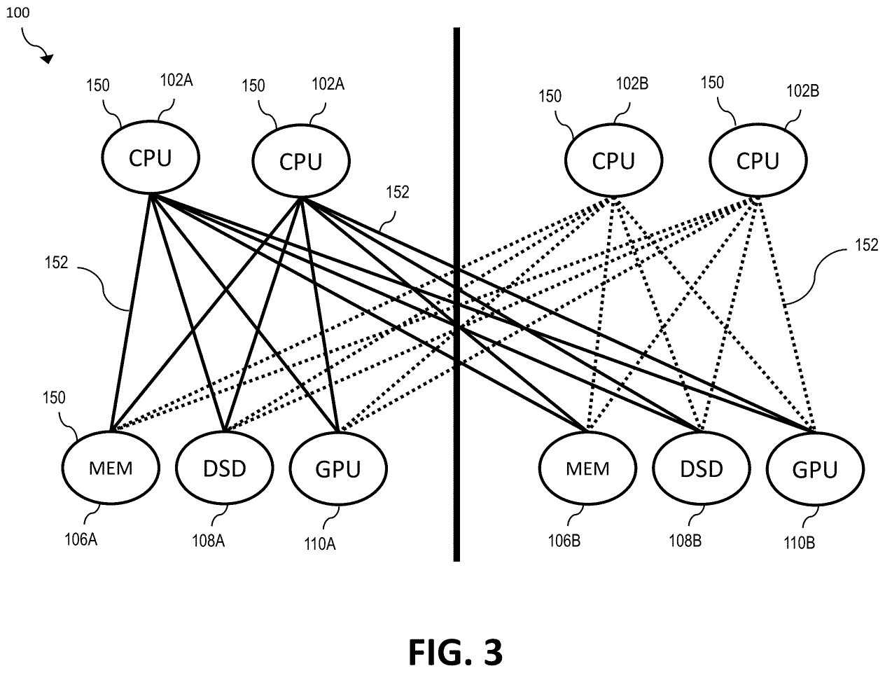

FIG. 3 shows a graphical representation of the various computing resources, memory resources, and data storage resources of the data storage system 100. The resources are represented by respective nodes 150 (sometimes called vertices) connected by edges 152 (sometimes called links). In the context of the data storage system 100 of FIG. 2, the edges 152 represent data paths between pairs of resources. For clarity, the graphical representation of FIG. 3 only includes a few resources as examples.

Each edge 152 can be assigned a weight, which is described in more detail below. As such, each pair of nodes 150 is associated with an edge 152 and a weight. The weight of each edge 152 can be dynamically updated, and the central controller 114 can be programmed to calculate and update the weights over time. As described in more detail below, the calculated weights can be used to determine which resource or set of resource are used for a given operation or application.

In certain embodiments, the edges 152 extend only between respective processing resources (e.g., the CPUs 104A and 104B and the GPUs 110A and 110B) and the other resources. In these embodiments, the memory 106A and 106B and the data storage devices 108A and 108B are controlled by the processing resources and only send or receive data to and from the processing resources. In certain embodiments, memory from any one of the resources in the system 100 (such as buffers physically part of the data storage devices 108A and 108B) can be accessed and use by another resource.

Each weight can comprise a static component and a dynamic component. The static component can represent the distance between pairs of resources along the fabric 112. In certain embodiments, the distance represents the number of switches (e.g., PCIe switches) between a given pair of resources. Passing data across a switch adds latency.

Because the distance (e.g., number of switches) between pairs of resources should not change over time, this contribution to the weight can be considered static. In certain embodiments, edges 152 between pairs of intra-enclosure resources do not have a static component because there is no performance penalty for accessing such resources. In embodiments with more than two enclosures, enclosures physically farther away from each other will have a larger static component. For example, in a three-enclosure data storage system, the enclosures may be connected in series. As such, resources in the enclosures farthest away from each other would be assigned a high static component weight to account for the longer distance data must travel from a resource located in one enclosure to a resource located in another enclosure. In some embodiments, a static component can be based on a given resources' performance characteristics (e.g., memory capacity, processing speed, available data storage capacity). Additionally or alternatively, if a given resource cannot meet a minimum performance requirement for a task, that resource may be excluded from the pool available resources.

The dynamic component of each weight can represent items accounted for by the weight that change over time. For example, the dynamic component can represent congestion between pairs of resources at a given moment of time. The congestion can affect intra-enclosure pairs of resources and inter-enclosure pairs of resources. Because congestion can vary over time and by location within the data storage system, the congestion's contribution to each weight can be dynamically updated. As another example, the dynamic component can be based, at least in part, on the current and/or planned input/output operations (IOPS) of each resource or the current, planned, and/or historical (e.g., average) performance of each resource. The CPUs can track the IOPS or performance of the resources. Resources that cannot meet the required IOPS or performance can be removed from contention or assigned a large dynamic weight component.

In certain embodiments, the static component and the dynamic component are added together to calculate the weight associated with each edge 152. The central controller 114 can then use the calculated weights—as described in more detail below—to manage allocation of the resources in the data storage system 100. In certain embodiments, the central controller 114 helps the CPUs 104A and 104B select which resources should be utilized to carry out an operation assigned to a given CPU.

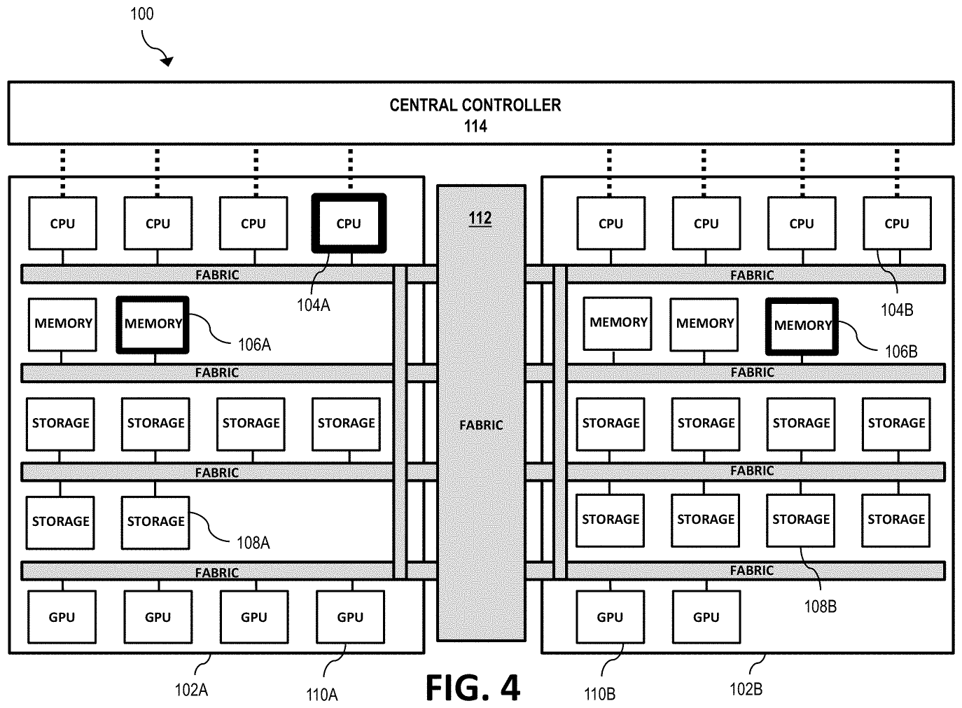

FIG. 4 show an example of how the central controller 114 can use the weights to determine which resource to use for a given operation. In short, the central controller 114 can determine what type(s) of resource pair(s) are needed, calculate weights of each type of resource pair, compare the calculated weights, and select the resource pair(s) with the lowest weight(s). The lowest weight should be associated with the pair of resources with the smallest performance or latency penalties caused by distance and congestion/performance.

FIG. 4 shows the data storage system 100 of FIG. 2 and its various components, which are described above. In the example of FIG. 4, one of the CPUs 104A (represented in a larger-weight border) in the first enclosure 102A is assigned to manage a computing task. This computing task may require access to an additional resource such as memory. To determine which memory resource to select, the central controller 114 can compare the calculated weighted data paths (along the fabric 112) between the given CPU 104A and the respective modules of memory 106A and 106B in each enclosure 102A and 1026 of the data storage system 100.

As a simple example, the respective weighted data paths between the one CPU 104A and the two modules of memory 106A and 1066 (represented in larger-weight borders) are compared. In the example, the memory 106A is in the same enclosure 102A as the CPU 104A, so there is no static component or a low static component. However, the memory 106A (and the other modules of memory 106A in the first enclosure 102A) may currently be carrying out other tasks such that there will be a delay before the memory is available. The central controller 114 can calculate a weight (or estimated amount of latency) that accounts for the latency and assign that weight or latency to the given memory. The memory 106B in the second enclosure 102B may be currently available, so the static component makes up most or all of the weight or latency. If the weight associate with the memory 106A is greater than the memory 106B, the memory 1066 can be selected. Once selected, the CPU 104A and the memory 1066 can transfer data between each other to carry out the computing task being managed by the CPU 104A. The data is transferred along the fabric 112.

In some embodiments, instead of making the resource selection when the task is initiated, the central controller 114 can migrate use of one resource to another resource while the task is being performed. For example, some tasks may take a significant amount of time to complete, so the central controller 114 can periodically determine whether a given task should be migrated from the currently selected resources to other resources. This migration may not occur all at once, and instead may be slowly migrated to avoid temporary performance penalties of the task at hand.

The central controller 114 may also migrate management of tasks from one CPU to another. For example, if the majority of the requested data for a task managed by a CPU is located in a different enclosure, if may be more efficient to migrate the task to a CPU in the same enclosure where the majority of the data is stored. Alternatively, the central controller 114 may migrate the data itself from one data storage device 108A in one enclosure 102A to another data storage device 108B in another enclosure 102B.

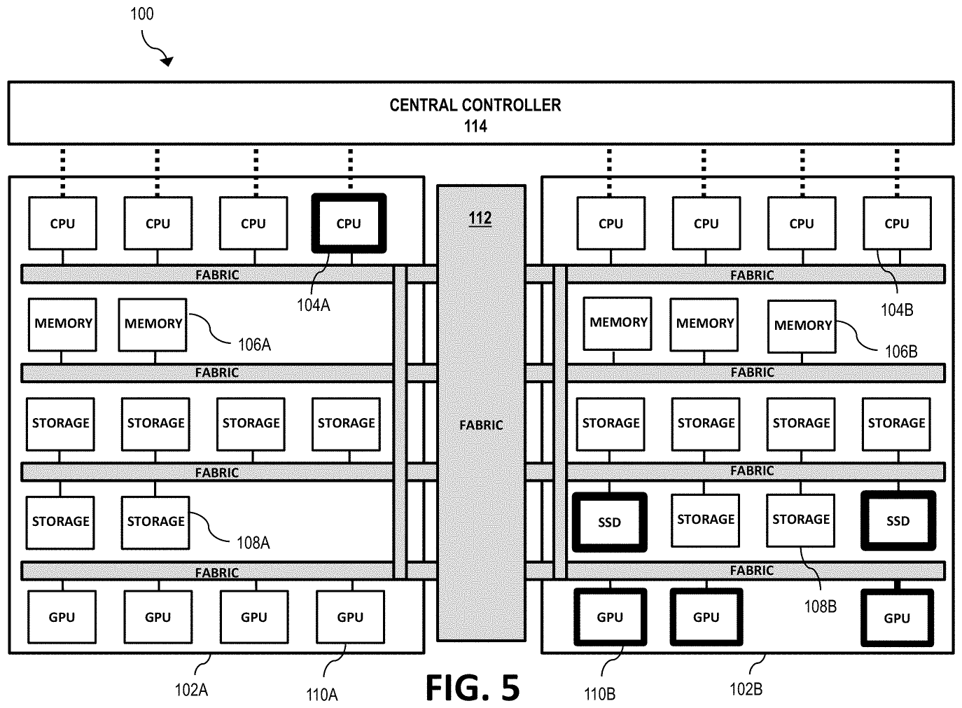

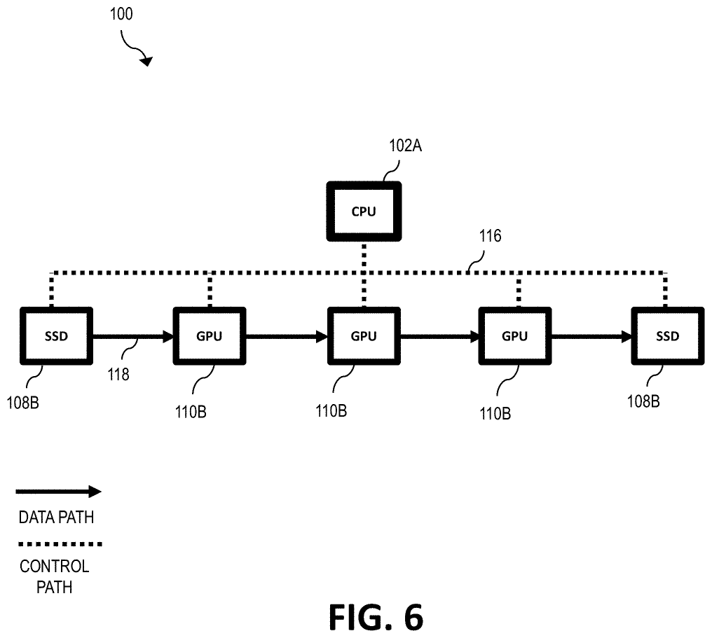

FIGS. 5 and 6 show the data storage system 100 of FIG. 2 and its various components, which are described above. In the example of FIG. 5, one of the CPUs 104A (represented in a larger-weight border) in the first enclosure 102A is assigned to manage a computing task. This particular computing task requires access and use of two data storage devices and three GPUs, which are represented in larger-weight borders in FIGS. 5 and 6. FIG. 6 shows a simplified schematic where only the CPU 104A and the selected resources are shown.

In this embodiment, instead of comparing the weighted paths between the CPU 102A and respective resources, the weighted paths between pairs of resources themselves are evaluated too. This is because—for the particular computing task—data needs to be transferred from one resource to another. In this embodiment, the CPU 102A is positioned in the first enclosure 102A while the selected resources are positioned in the second enclosure 102B. Because data needs to be passed between resources, the overall lowest weighted path passes across resources in the same enclosure. Put another way, the central controller 114 can compare overall weighted paths (e.g., a sum of weighted paths) across various combinations of multiple resources and determine which particular overall path results in the lowest weight.

As shown in FIG. 6, the CPU 102A communicates with the resources via a control path 116 of the fabric 112 while the resources communicate with each other along a data path 118. As such, in this embodiment, the paths between resources has a larger affect on performance compared to paths between the CPU and individual resources. The particular combination of selected resources shown in FIGS. 5 and 6 may arise when the CPU 102A is carrying out a machine learning application. The CPU 102A may issue a read command (e.g., a NVMe read command) to a data storage device (e.g., a solid-state drive) where the target of the read data is one of the GPUs. Multiple GPUs may be used to carry out the computing task, and another data storage device may store the result of the computations from the GPUs. The CPU 102A can then read the result from the data storage device.

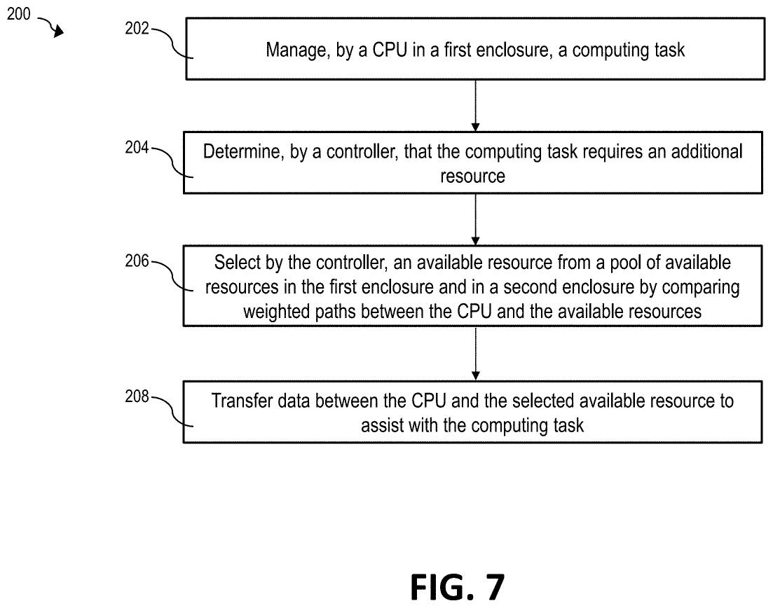

FIG. 7 outlines a method 200 for managing use of resources in a system using a disaggregated architecture. The method 200 includes managing, by a first CPU in a first enclosure, a computing task (block 202 in FIG. 7). The method 200 further includes determining, by a controller, that the computing task requires an additional resource (block 204 in FIG. 7). Next, the controller selects an available resource from a pool of available resources in the first enclosure and in a second enclosure by comparing weighted paths between the first CPU and the available resources (block 206 in FIG. 7). Data is then transferred between the first CPU and the selected available resource to assist with the computing task (block 208 in FIG. 7).

At any given point in time, the system 100 described above may be performing the method 500—and other functions described herein—simultaneously with multiple CPUs, each managing one or more computing tasks and tapping into the pool of resources to help carry out the computing tasks.

In certain embodiments, the various methods and function described herein can be performed via a combination of software and hardware. For example, the system 100 can include a non-transitory computer-readable medium (e.g., memory) that stores instructions that, when executed by a processor (e.g., a microprocessor of the central controller 114) cause the processor to perform the various methods and functions.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

I claim:

1. A method comprising:
managing, by a first computer processing unit (CPU) in a first enclosure, a computing task;
determining, by a controller, that the computing task requires an additional resource;
selecting, by the controller, a first available resource from a pool of resources in the first enclosure and in a second enclosure by comparing weighted paths between the first CPU and the available resources; and
transferring data between the first CPU and the selected first available resource to assist with the computing task.

2. The method of claim 1, further comprising:
selecting, by the controller, a second available resource from the pool of resources; and
transferring data between the first CPU and the selected second available resource to assist with the computing task.

3. The method of claim 2, wherein the selected first available resource is either a data storage device, a graphical processing unit (GPU), or memory, and wherein the selected second available resource is either a data storage device, a graphical processing unit (GPU), or memory.

4. The method of claim 3, wherein the selected first available resource is of a different type of resource than the selected second available resource.

5. The method of claim 2, wherein the selected first available resource is positioned in the first enclosure, and wherein the selected second available resource is positioned in the second enclosure.

6. The method of claim 1, wherein each resource within the pool of available resources is communicatively coupled to a fabric.

7. The method of claim 6, wherein the fabric comprises a data bus.

8. The method of claim 7, wherein the data bus is a peripheral component interconnect express (PCIe) data bus.

9. The method of claim 1, wherein weighted paths are based, at least in part, on a number of switches between the first CPU and individual resources within the pool of resources.

10. The method of claim 1, wherein the weighted paths are based, at least in part, on a static component and a dynamic component, which changes over time.

11. The method of claim 1, wherein the weighted paths are associated with edges between pairs of nodes, wherein one of the nodes represents the first CPU.

12. The method of claim 1, wherein the comparing the weighted paths includes determining the weighted path associated with the lowest weight.

13. A system comprising:
a central controller comprising memory that stores instructions, which, when executed, cause the central controller to:
select a first available resource from a pool of resources—each communicatively coupled to a fabric—in a first enclosure and in a second enclosure by comparing a first set of weighted paths between a CPU and a first type of the resources,
select a second available resource from the pool of resources by comparing a second set of weighted paths between the CPU and a second type of the available resources that is different than the first type, and
instruct the CPU to access the selected first available resource and the selected second available resource via the fabric and to transfer data between the CPU and the selected first and second available resources to assist with a computing task managed by the CPU.

14. The system of claim 13, further comprising:
the first enclosure housing a first portion of the pool of resources comprising a first set of data storage devices, a first set of memory, and a first set of graphical processing units;
the second enclosure housing a second portion of the pool of resources comprising a second set of data storage devices, a second set of memory, and a second set of graphical processing units; and
the fabric.

15. The system of claim 14, wherein the fabric includes a set of switches, wherein a weight of each of the weighted paths is based, at least in part, on the number of switches between the CPU and a given one of the resources.

16. The system of claim 14, wherein the fabric comprises a peripheral component interconnect express (PCIe) data bus.

17. The system of claim 14, further comprising:
a first set of CPUs, including the CPU, positioned in the first enclosure and communicatively coupled to the fabric; and
a second set of CPUs positioned in the second enclosure and communicatively coupled to the fabric.

18. The system of claim 13, wherein the selected first available resources and the selected second available resource are selected based on the weighted paths associated with the lowest weight.

19. The system of claim 13, wherein the weighted paths are based, at least in part, on a static component and a dynamic component.

20. A non-transitory computer-readable medium having stored thereon instructions that, when executed by a processor, cause the processor to:
select a first available resource from a pool of resources—each communicatively coupled to a fabric—in a first enclosure and in a second enclosure by determining which path of a first set of weighted paths between a CPU and a first type of the resources is associated with a lowest weight,
select a second available resource from the pool of resources by determining which path of a second set of weighted paths between the CPU and a second type of the resources is associated with a lowest weight, and
instruct the CPU to access the selected first available resource and the selected second available resource via the fabric and to transfer data between the CPU and the selected first and second available resources to assist with a computing task managed by the CPU.
